(19) United States
(12) Patent Application Publication
(10) Pub. No.: US 2002/0110627 A1
(43) Pub. Date: Aug. 15, 2002

(54) Baking container

(76) Inventor: Kunihiro Hirano, Gifu-ken (JP)

Correspondence Address: Gary A Hecht, Synnestvedt & Lechner LLP, 2600 Aramark Tower, 1101 Market Street, Philadelphia, PA, 19107-2950, US

(21) Appl. No.: 09/575,067

(22) Filed: May 19, 2000

(30) Foreign Application Priority Data
May 21, 1999 (JP) 11-142044
May 11, 2000 (JP) 2000-138626

(51) Int. Cl. A23C 3/00

(52) U.S. Cl. 426/523

(57) ABSTRACT

A baking container for holding dough, which is baked into a product such as bread. The baking container includes a container body, which is formed by molding slurry paper material. A silicone film is formed on the surface of the container body. Therefore, the product is easily separated from the baking container, and the container is easily separated from another container when the containers are stacked.

### BACKGROUND OF THE INVENTION

The present invention relates to a baking container for determining the shape of breads, cakes, puddings, chocolates and the like.

Typically, dough is baked into a shape corresponding to the inner walls of the baking container. For example, bread dough expands along the inner shape of the container when heated, and the resulting bread has the corresponding shape.

However, there may be a case in which a product cannot be easily separated from the container due to the characteristics of the dough. The product is especially likely to stick to the inner surface of the container when the design of the product is complicated, for example, when recesses and projections are formed on the inner surface to obtain the shape of animals.

One way to solve the problem is to apply edible oil on the inner surface of the container before placing dough in the container. This facilitates separating the product from the container.

Another way to solve the problem is to sell the product together with the baking container. That is, the baking container also serves as part of a wrapping container. This saves the manufacturer from the trouble of separating the product from the baking container.

In the former way, deteriorated oil produces an odor. Therefore, the baking container has to be cleaned after it is used. Also, applying edible oil every time the container is used is troublesome.

In the latter way, since the baking container is disposed and is not reused, the costs are greater. Generally, baking containers are stacked, and they are taken off one by one when used. If the containers are not easily separated from one another, the production efficiency is lowered.

In the above two methods, the problem of separating the stacked containers remains unsolved.

### SUMMARY OF THE INVENTION

An objective of the present invention is to provide a baking container that is easily separated from a stack.

To achieve the above objective, the present invention provides a container for determining a shape of dough. The container includes a container body. The container body is formed into a predetermined shape by molding slurry paper material. A silicone film is formed on the surface of the container body.

The present invention further provides a method for manufacturing a container that determines a shape of dough. The method includes steps of forming a container body molding a slurry paper material, applying base film on the surface of the container, and forming a silicone film on the base film.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a cross-sectional view of a baking container according to a first embodiment of the present invention; and

FIG. 2 is a cross-sectional view of a baking container according to a second embodiment.

### DETAILED DESCRIPTION OF THE PREFERRED EMBODIMENTS

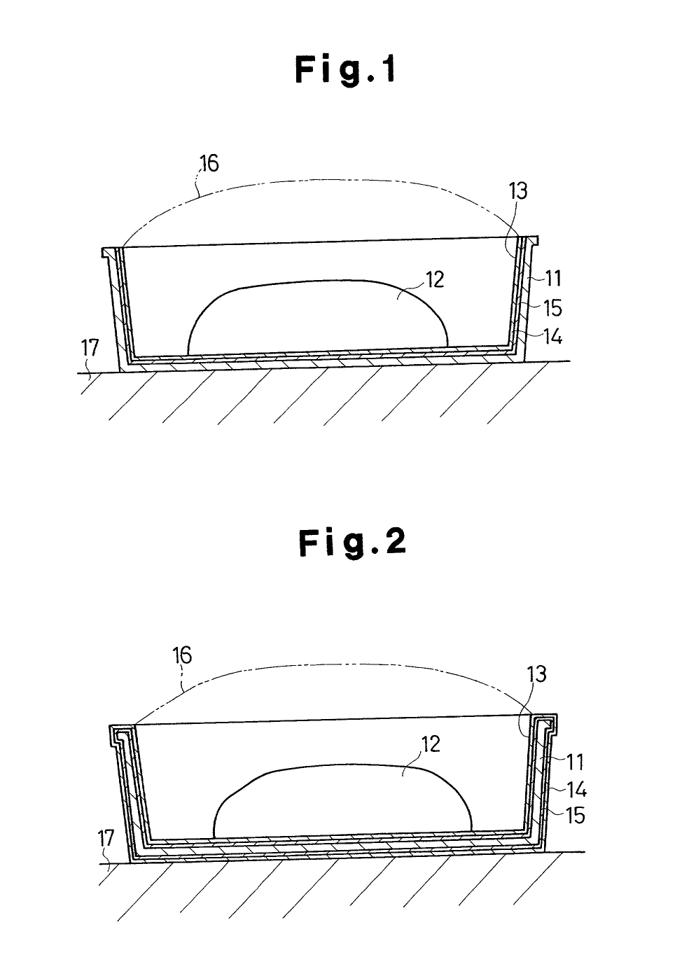

A baking container according to a first embodiment of the present invention will now be described with reference to FIG. 1.

The baking container body 11 is made of molded pulp. The container body 11 is made by molding slurry paper material that mainly includes pulp. The container body 11 is a shallow tray with a tubular side wall. At least one accommodation space 13 is formed in the container body 11 to accommodate dough 12. The container body 11 may be formed in any shape as long as at least one accommodation space 13 is formed. The top plan view of the container body 11 may be circular, polygonal, star-shaped, annular, animal-shaped, and the like.

A silicone film 14 is formed on the inner surface of the accommodation space 13. A base film 15 is formed between the container body 11 and the silicone film 14.

The silicone film 14 is formed by hardening liquid silicone. The silicone film 14 facilitates separating a product 16 from the container. The silicone includes material such as a silicone oil diluted by organic solvent, a silicone resin diluted by organic solvent, an emulsified silicone oil, an emulsified silicone resin, non-solvent-type silicone oil, and non-solvent-type silicone resin. Hardening of the silicone is accelerated by a catalyst including metal salt such as platinum compound.

The silicone film 14 is firmly attached to the inner surface of the container body 11 by the base film 15. The base film 15 also prevents the silicone from permeating into the container body 11. The base film 15 is formed by hardening material such as latex, polyvinyl alcohol solution, and starch solution.

The manufacturing method of the illustrated baking container will now be described.

First, suspension of pulp and water is made. The pulp may include one or combination of conifer, broadleaf tree, used paper, straw, linen, cotton, bamboo, kenaf, bagasse, and starch. Also, chemical fiber such as rayon, polyamide fiber, polyester fiber may be added to the pulp.

Next, the suspension is beaten to a predetermined degree by a beater or refiner. Further, size agent such as rosin, gelatin and other agents are added to the suspension to prepare a slurry paper material. The step of adding the agents does not have to follow the beating step.

Subsequently, the paper material is poured into a predetermined mold. Then, the material is pressed, which squeezes out water in the paper material. Then, the material is naturally or forcibly dried, which completes the container body 11. The material may be forcibly dried by far-infrared radiation.

Subsequently, the base film 15 and the silicone film 14 are formed on the inner surface of the container body 11. A base agent (latex), which is commercially available, is applied to the inner surface of the container body 11 by brush, immersion, or spraying and is dried naturally or forcibly, which forms the base film 15. The base agent may be diluted by water. For example, the amount of water added to the base agent is below 100 cm³ per 100 cm³ base agent, preferably 15-45 cm³.

The solid amount of base agent applied to the inner surface of the container body 11 is 5 g/m² and preferably 6-12 g/m². When the amount is below 5 g/m², the base film 15 does not function satisfactorily. If the amount is above 25/m², the cost performance is lowered.

Next, a catalyst (platinum compound in the present embodiment) is added to the liquid silicone. The mixture is applied to the base film 15 by brush, immersion, or spraying and is dried naturally or forcibly, which forms the silicone film 14. The amount of catalyst added to liquid silicone is 0.1-10 cm³ per 100 cm³ silicone and preferably 1-5 cm³. If the amount of catalyst added is below 0.1 cm³ per 100 cm³ silicone, the catalyst does not function efficiently. If the amount is above 100 cm³, hardening advances too quickly. The silicone may be diluted by water. The amount of water added is below 50 cm³ per 100 cm³ silicone and preferably 5-20 cm³.

The solid amount of silicone applied is 0.5-15 g/m² and preferably 1-10 g/m². If the amount is below 0.5 g/m², the silicone film 14 does not function efficiently. If the amount is above 15 g/m², the cost performance is lowered.

The base agent, which is a base coating agent such as latex, includes approximately 46% solid. The viscosity of the base agent is measured by a Zahn cup viscometer No.3, which is well-known, which takes 12.2 seconds. In the measuring method, a Zahn cup No.3 is filled with a sample, and the time that is taken for the whole sample to flow through a bottom hole of the cup is measured. The viscosity of the sample is determined by the time required. The silicone composition includes 16.5-19.5% solid and water as volatile component. The measurement of viscosity of the silicone composition using Zahn cup No.3 takes 30-40 seconds.

The usage of the baking container will now be described. Instead of baking dough of cakes and breads, the container can be used for determining the shape of products that are made by steaming or cooling.

When the product 16 is bread, the dough 12 is placed in the accommodation space 13, and the baking container is placed on a heating plate 17, which is heated. The bread dough is heated through the container and baked into bread having the shape corresponding to the accommodation space 13. Cake dough may be used instead of bread dough.

The present embodiment has the following advantages.

Since the silicone film 14 is formed on the inner surface of the accommodation space 13 of the container body 11, the product 16 contacts the silicone film 14 and does not directly contact the container body 11. Accordingly, the product 16 is easily separated from the container body 11. Therefore, the product 16 can be sold without the baking container, which permits repetitive usage of the baking container. Even if the design of the product 16 is complicated and there are recesses and projections on the inner surface of the accommodation space 13, the product 16 can be readily separated from the baking container.

When baking containers are stacked, the inner surface of one container contacts the outer surface of another container. Therefore, the container bodies 11 do not directly contact one another, and silicone film 14 is located between the container bodies 11. Accordingly, each baking container is easily separated from the stack of containers. This also improves the efficiency when a robot arm carries the stacked containers one by one to a manufacturing line, for example, by suction.

The base film 15 is formed between the container body 11 and the silicone film 14, and the silicone film 14 is firmly attached to the surface of the container body 11 by the base film 15. Therefore, the durability of the silicone film is fairly high. For example, the baking container can be used for baking bread fifty times. The baking container avoids the trouble of applying edible oil to the baking container before using it. The baking container may be coated by a new silicone film before reusing.

Since a catalyst is added to silicone to accelerate its hardening, the silicone film 14 is formed at a relatively low 90-180 degrees Celsius temperature for a relatively short five to sixty seconds period. This prevents damage to the container body 11 and reduces heating cost. Adding catalyst can also make the silicone film 14 harder.

The silicone film 14 is stable regardless of heat and is hardly acidified. Therefore, odors like that of deteriorated edible oil are not produced. This simplifies the maintenance of the container after using.

The main material for the container body 11 is pulp, which reduces manufacturing costs. Also, the container body is easily disposed of by burning. Further, the container body efficiently radiates heat and is quickly cooled, which permits a worker to carry the container with bare hands.

The container body 11 is formed by pouring paper material into a mold having a predetermined shape. Accordingly, the container body 11 is easily formed into a predetermined shape. Molded pulp has been used as cushion material replacing styrene foam, and using molded pulp as a baking container is new.

The silicone film 14 is formed only on the inner surface of the accommodation space 13 of the container body 11. Therefore, only the minimum amount of silicone that is necessary to separate the container from one another is used, which reduces manufacturing costs.

The illustrated embodiment can further be varied as follows.

The base film 15 may be omitted, and the silicone film 14 may be formed directly on the surface of the container body 11.

As shown in FIG. 2, the base film 15 may be formed on the entire surface of the container body 11, and the silicone film 14 may be formed on the entire surface of the base film 15. In this case, dough that attached to a surface of the container outside the accommodation space 13 is easily removed, which keeps the container clean.

The baking container may also serve as a wrapping container for carrying or selling the dough 12 or the product 16.

The baking container may be used in a freezer for preserving the dough 12 that is placed in the accommodation space 13. Thereafter, the dough 12 in the container may be carried to a separate baking location.

It should be apparent to those skilled in the art that the present invention may be embodied in many other specific forms without departing from the spirit or scope of the invention. Therefore, the present examples and embodiments are to be considered as illustrative and not restrictive and the invention is not to be limited to the details given herein, but may be modified within the scope and equivalence of the appended claims.

What is claimed is:

1. A container for determining a shape of dough, the container comprising:
a container body, which is formed into a predetermined shape by molding slurry paper material; and
a silicone film, which is formed on the surface of the container body.

2. The container according to claim 1, wherein a base film is formed between the container body and the silicone film such that the adhesion between the container body and the silicone film is increased.

3. The container according to claim 1, wherein a catalyst is added to accelerate hardening of the silicone film.

4. The container according to claim 3, wherein the catalyst is a platinum compound.

5. The container according to claim 1, wherein the material of the container body is mostly pulp.

6. The container according to claim 1, wherein the container includes an accommodation space, wherein the silicone film is formed only on a surface defining the accommodation space.

7. A method for manufacturing a container that determines a shape of dough, the method comprising:
forming a container body molding a slurry paper material;
applying a base film on the surface of the container; and
forming a silicone film on the base film.

8. The method according to claim 7 including adding a catalyst to accelerate hardening of the silicone film.

9. The method according to claim 7 including adding a platinum compound as a catalyst to accelerate hardening of the silicone film.

10. The method according to claim 7 including molding the material of the container body that is mostly pulp.

11. The method according to claim 7 including forming an accommodation space in the container and forming the silicone film only on the inner surface of the accommodation space.
